(19) United States
(12) Patent Application Publication
(10) Pub. No.: US 2016/0124526 A1
(43) Pub. Date: May 5, 2016

(54) SOFT MOUSE PAD AND AN ASSOCIATED ILLUMINATING METHOD

(71) Applicant: Hades-gaming Corporation, New Taipei City (TW)

(72) Inventor: Hung-Jen Chou, New Taipei City (TW)

(21) Appl. No.: 14/924,741

(22) Filed: Oct. 28, 2015

(30) Foreign Application Priority Data
Oct. 30, 2014 (TW) 103219219

(51) Int. Cl. G06F 3/039; F21V 23/06; F21V 11/16; F21V 33/00

(52) U.S. Cl. CPC G06F 3/0395; F21V 33/0048; F21V 23/06; F21V 11/16; F21Y 2101/02

(57) ABSTRACT

A present disclosure disclosed a mouse pad and an associated illuminating method includes a fabric surface and a light transmissive pad. The fabric surface has at least one opening for light being able to emit through the opening that forms a visual reception. The visual reception may be marquee, bright permanency or gradients, which provides a special interacting illumination on the mouse pad.

### FIELD OF THE INVENTION

Embodiments of the present invention relate to a mouse pad, particularly relate to a soft mouse pad and an associated illuminating method.

### BACKGROUND

A mouse pad is usually divided as a soft or a hard mouse pad. The hard mouse pad has a surface printed with clarified figures or words, is produced with simpler manufacturing process, is hard to be folded to take away. The soft mouse pad has a fabric surface and is convenient to be carried due to the foldable property. An edge of the fabric surface is ragged, peeled off or damaged after normality operation. Both soft and hard mouse pad are usually applied as an advertising tool to promote a specific product, and are focused on precisely sensing of the mouse movement. However, a visual reception of the mouse pad may not serve as a main point to attract the customer and increase the purchase behavior.

Some manufactures now are trying to develop a mouse pad with an illuminating module, such as a light emitting diode (LED) or a cold cathode fluorescent lamp (CCFL). Different arrangements of the illuminating module and emitting pattern will able to improve the visual reception. But such application is still designed on the hard mouse pad with disadvantaged of inconvenient to be folded and carried.

Accordingly, a soft mouse with illuminating reception is able to be folded and carried is a new field to the mouse pad industry.

### SOME EXEMPLARY EMBODIMENTS

These and other needs are addressed by the present invention, wherein an approach is provided for a soft mouse pad to emit a light through an opening from an illuminating module embedded inside the soft mouse pad.

One aspect of the present invention is to provide a soft mouse pad. The soft mouse pad comprises a fabric surface and a light transmissive pad. The fabric surface has at least one opening. The light transmissive pad has an illuminating module, and is tightly attached with the fabric surface by a heat pressing. The opening of the fabric surface is vertically corresponded to the illuminating module to emit light through the opening and form a visual reception.

The visual reception can be a marquee, bright permanency and/or gradients.

Another aspect of the present invention is to provide a method to generate an illumination interaction of a soft mouse pad, comprises steps of: connecting a mouse pad to a computer, a micro controller unit (MCU) of the computer determining the illuminating module as an error mode when the computer do not recognize a USB of the mouse pad, the MCU determining the illuminating module as an alarm mode when the mouse pad receiving an information, and the MCU determining the illuminating module as a power-on mode when the mouse pad do not receive any information.

Accordingly, the mouse pad of the present invention is foldable, and is able to emit uniform light through the opening to form a visual reception. The visual reception is determined by an operation rule to provide a special interacting illumination on the mouse pad.

### BRIEF DESCRIPTION OF THE DRAWINGS

The invention is illustrated by way of example, and not by way of limitation, in the figures of the accompanying drawings in which like reference numerals refer to similar elements and in which:

FIG. 1 shows a soft mouse pad in accordance with the present invention.

FIG. 2 is a cross-section view alone the line A-A in FIG. 1.

FIG. 3A is an embodiment of a light conductive panel of an illuminating module in accordance with the present invention.

FIG. 3B is another embodiment of the light conductive panel of the illuminating module in accordance with the present invention.

FIG. 4 is a flow chart showing a method to generate an illumination interaction of a mouse pad.

### DESCRIPTION OF THE PREFERRED EMBODIMENT

A mouse pad and an associated illuminating method are disclosed. In the following description, for the purposes of explanation, numerous specific details are set forth in order to provide a thorough understanding of the present invention. It is apparent, however, to one skilled in the art that the invention may be practiced without specific details or with an equivalent arrangement. In other instances, well-known structures and devices are shown in block diagram form in order to avoid unnecessarily obscuring the embodiments of the present invention.

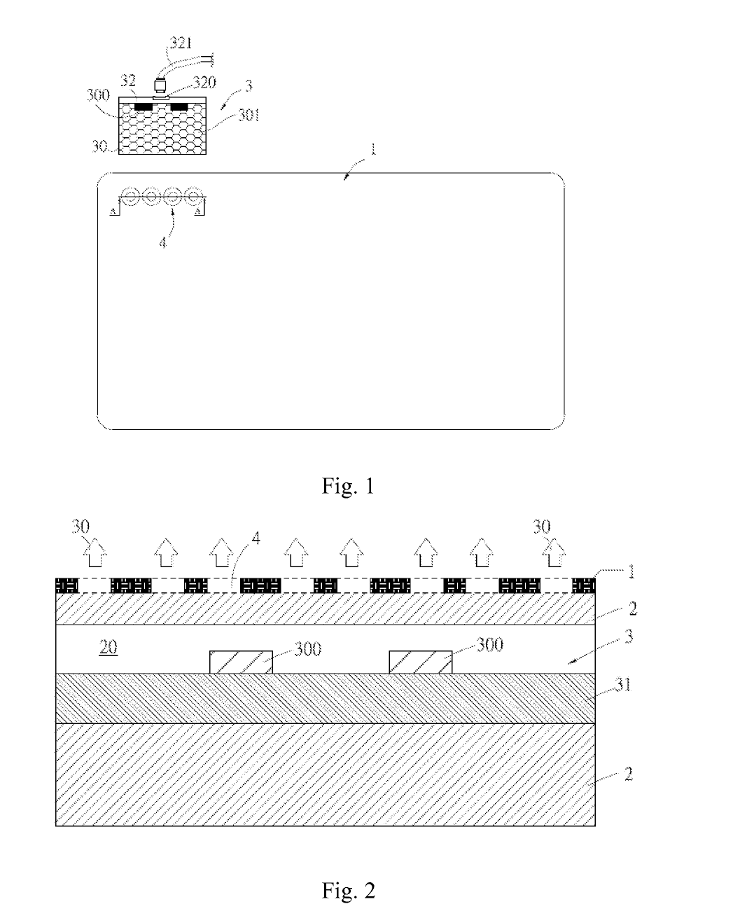

With reference to FIGS. 1 and 2, FIG. 1 shows a soft mouse pad in accordance with the present invention. FIG. 2 is a cross-section view alone the line A-A in FIG. 1. In this embodiment, a mouse pad comprises a fabric surface 1 and a light transmissive pad 2. The light transmissive pad 2 comprises an illuminating module 3. The fabric surface 1 has at least one opening 4, is subsidiary cemented on a surface of the light transmissive pad 2 by heat pressing, and corresponds to the illuminating module 3. A visual light 30 is transmitted from the illuminating module 3 to the outside of the fabric surface 1 through the opening 4.

The light transmissive pad 2 is made of a silicon or a foaming material. A viscous silicon is permeated between the fabric surface 1 and the light transmissive pad 2 before heat pressing the mouse pad. Optional, a cross linking agent is applied to improve the viscosity of the viscous silicon. Therefore, the fabric surface 1 and the light transmissive pad 2 are attached tightly after the viscous silicon permeating into the fiber of the fabric surface 1 due to material homogeneity in the heat pressing process.

The opening 4 is laser engraving after heat pressing the fabric surface 1 and the light transmissive pad 2 to simplify the manufacturing process and improve the production yield.

In this embodiment, the light transmissive pad 2 has a groove 20. The groove 20 is used to dispose the illuminating module 3. The illuminating module 3 comprises a light conductive panel 31. An edge of the light conductive panel 31 has at least one light emitting diode (LED) source 300. A surface of the light conductive panel 31 is disposed with multiple light conductive points 301. The light conductive points 301 transform the line source of the LED source 300 as a uniformed area source spread above the light conductive panel 31. As shown in FIG. 2, the visual light 30 from the light conductive panel 31 will emit to the outside of the fabric surface 1 through the opening 4.

The illuminating module 3 also comprises a circuit 32 that is connected to the light conductive panel 31 and comprises a connection port 320. The circuit 32 is drove by connecting an outer wire 321 to a power source and drives at least one LED source 300 through the connection port 320 according to an operation rule. A port of the outer wire 321 corresponds to a port of the connection port 320. In this embodiment, the connection port 320 is a universal serial bus (USB). The outer wire 321 connects to a computer or an USB hub through the USB.

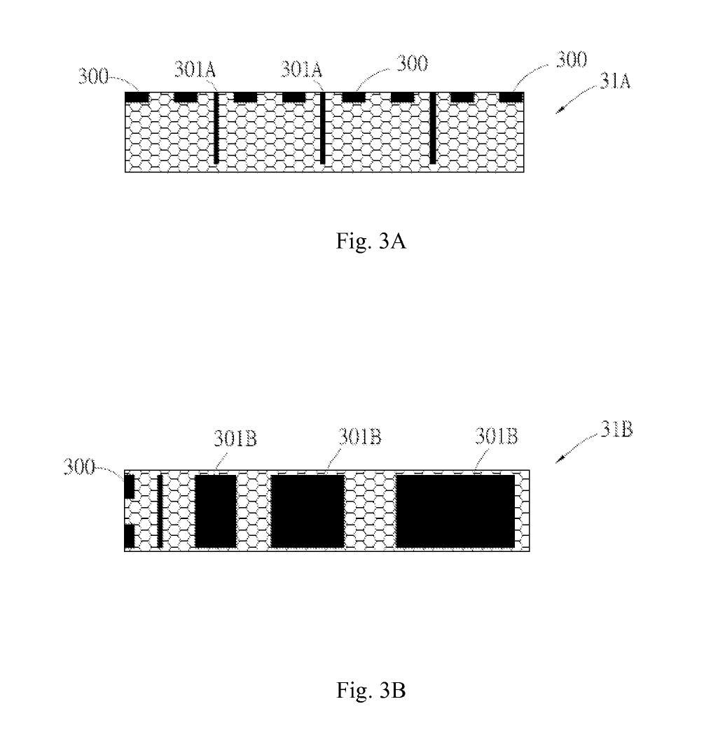

With reference to FIGS. 3A and 3B, FIG. 3A is an embodiment of a light conductive panel of an illuminating module in accordance with the present invention. FIG. 3B is another embodiment of the light conductive panel of the illuminating module in accordance with the present invention. In order to conveniently illustrate the light conductive panel 31A, 31B, the circuit 32 and the connection port 320 are omitted. Moreover, the method to drive at least one LED source 300 is well known by the person of ordinary skill in the art.

With reference to FIG. 3A, in this embodiment, the light conductive panel 31A is a rectangle. Each longer edge comprises 4 LED sets include 8 horizontally arranged LED sources 300. A shading strip 301A is disposed between LED sets on the surface of the light conductive panel 31A. Therefore, the light conductive panel 31A is divided into 4 area sources. However, the shading strip 301A also provides a shadow to block the visual light passes through. When the circuit turns on and off the LED sources 300, the emitted visual light forms a visual reception as a marquee (news ticker).

With reference to FIG. 3B, in another embodiment, he light conductive panel 31B is also a rectangle. Each shorter edge comprises 2 vertically disposed LED sources 300. Multiple shading strips 301B are horizontally disposed to the LED sources 300. The shading strip 301B far away from the LED sources 300 is thicker to form a larger shadow and a gradient visual reception.

It should be noticed that the operator determines the operation rule by the connection port 320 of USB. The operation rule includes emitting marquee, bright permanency or gradient. Each LED source 300 comprises at least one LED unit. Each LED unit might have different color or color temperature to adjust or mix the emitted light and generate different visual reception.

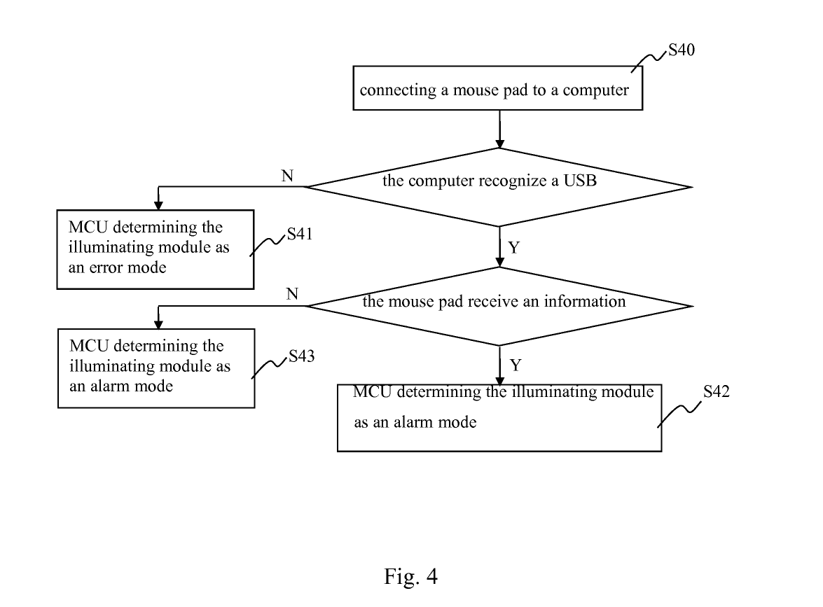

With reference to FIG. 4, FIG. 4 is a flow chart showing a method to generate an illumination interaction of the mouse pad. When the mouse pad of the present invention connects to the computer by a USB wire, the mouse receives data from the computer. The illuminating module enables an illuminating mode of the illuminating module based on the received data. The illuminating mode of the mouse pad includes a power-on mode, a alarm modeand an error mode. Each mode corresponds to a specific illuminating mode. The illuminating module is directly driven the circuit or is determined as the power-on mode, the alarm modeor the error mode by a micro controller unit (MCU).

In the present invention, the mouse pad comprises an illuminating module and a micro controller unit (MCU). The method to operate the illumination interaction of the mouse pad comprises steps of:

S40: connecting a mouse pad to a computer;

S41: the MCU determining the illuminating module as an error mode when the computer do not recognize a USB of the mouse pad;

S42: the MCU determining the illuminating module as an alarm mode when the mouse pad receiving an information; and

S43: the MCU determining the illuminating module as a power-on mode when the mouse pad do not receive any information.

The hint of S42 MCU determining the illuminating module as an alarm mode when the mouse pad receiving an information includes receiving a mew Email or an instant message. For example, when the computer receives a new Email, the computer generates an information to drive the mouse pad in the alarm mode.

In an embodiment, the error mode, the alarm mode and the power-on mode of the mouse pad emits a constant red light, a sparkling light and a constant white light respectively.

Accordingly, the mouse pad of the present invention is foldable, is able to emit uniform light that is performed through the opening that forms a visual reception. The visual reception is determined by an operation rule to generate illumination interaction.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A soft mouse pad, comprising:
a fabric surface having at least one opening; and
a light transmissive pad having an illuminating module, and being tightly attached with the fabric surface by a heat pressing, the opening of the fabric surface is vertically corresponded with the illuminating module to emit light through the opening and form a visual reception.

2. The soft mouse pad as claimed in claim 1, wherein the light transmissive pad comprising a groove to dispose the illuminating module.

3. The soft mouse pad as claimed in claim 1, wherein the illuminating module comprising a light conductive panel, an edge of the light conductive panel has at least one light emitting diode (LED) source.

4. The soft mouse pad as claimed in claim 3, wherein the illuminating module comprising a circuit connected with the light conductive panel.

5. The soft mouse pad as claimed in claim 4, wherein the circuit having a connection port to obtain a power source to enable the circuit to generate the light emitting diode source

6. The soft mouse pad as claimed in claim 5, wherein the connection port is a universal serial bus (USB).

7. The soft mouse pad as claimed in claim 3, wherein the illuminating module driving the LED source based on an operation rule.

8. The soft mouse pad as claimed in claim 3, wherein the light conductive panel having a longer edge has multiple horizontally disposed LED sources.

9. The soft mouse pad as claimed in claim 8, wherein the light conductive panel comprising at least one shading strip, the shading strip is disposed on a surface of the light conductive panel to divide the light conductive panel into 2 area sources.

10. The soft mouse pad as claimed in claim 3, wherein the light conductive panel having a shorter edge has multiple horizontally disposed LED sources.

11. The soft mouse pad as claimed in claim 10, wherein the light conductive panel having a surface disposed with multiple shading strips paralleled to the multiple horizontally disposed LED sources.

12. The soft mouse pad as claimed in claim 11, wherein the shading strips being getting thickened from the LED sources.

13. The soft mouse pad as claimed in claim 1, wherein the visual reception being marquee, bright permanency and gradients.

14. The soft mouse pad as claimed in claim 1, wherein the LED source comprising at least one LED unit, each LED unit has different color or color temperature.

15. A method to generate an illumination interaction of a soft mouse pad, comprising steps of:
connecting a mouse pad to a computer;
determining the illuminating module as an error mode when the computer do not recognize a USB of the mouse pad by a micro controller unit (MCU) of the computer;
determining the illuminating module as an alarm mode when the mouse pad receiving an information by the MCU; and
determining the illuminating module as a power-on mode when the mouse pad do not receive any information by the MCU.

16. The method as claimed in claim 15, wherein the information including a mew Email and an instant message.
